(19) United States
(12) Patent Application Publication
(10) Pub. No.: US 2010/0019722 A1
(43) Pub. Date: Jan. 28, 2010

(54) Self-Charging Electric Vehicles (SC-EV) Regeneration Component

(76) Inventor: David M. Sanchez, Bedford, TX (US)

Correspondence Address: David M. Sanchez, 3613 Harwood Ct, Bedford, TX, 76021, US

(21) Appl. No.: 12/228,067

(22) Filed: Jul. 22, 2008

(51) Int. Cl. H02J 7/00; H02K 53/00

(52) U.S. Cl. 320/109; 415/916

(57) ABSTRACT

The use of alternators to provide extra battery power to the engines of electric vehicles and enable the vehicles to have extended ranges. Placing two alternators near the rear axles of a vehicle with belts driven by a sleeve-device would then provide electrical power to the batteries to extend the battery power and thus the range of the vehicle.

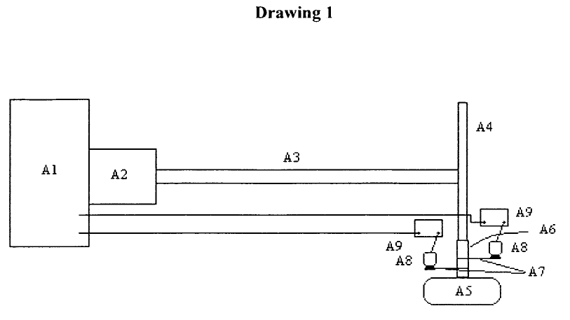

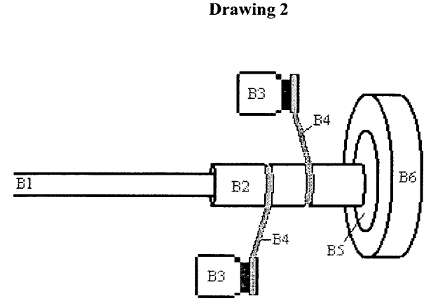

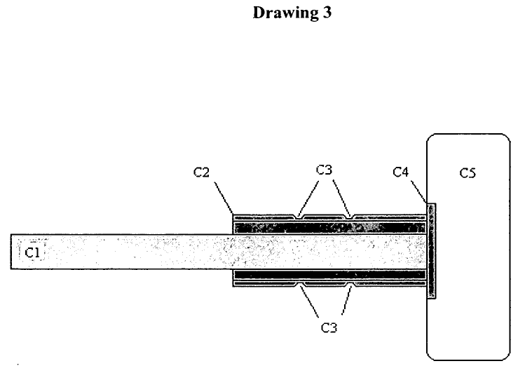

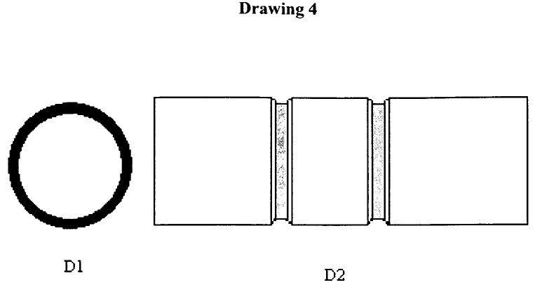

### CROSS-REFERENCE TO RELATED APPLICATIONS

This application claims the benefit of Provisional patent application Ser. No. 12/228,067 filed in July 2008 by the present inventor.

Initial Provisional Patent Application No. 61/082,655

### FEDERALLY SPONSORED RESEARCH

Not Applicable

### BACKGROUND—FIELD OF INVENTION

This patent submission of the Self-Charging Electric Vehicle Range Extender Component relates to extending the range of battery-powered electric vehicles (pre-existing/prior art) by deploying alternator technology in different methodology than previously used.

### Substitute Specification:

The below is the Substitute Specification as required correcting the issues in the letter dated 11 Nov. 2008.

This is the statement required stating that there is no new matter submitted.

### Current Situation (Prior Art):

1. America is tied to internal combustion engines (ICEs) that use fossil fuels such as gasoline, diesel, and oil. Fossil fuels are getting shorter and shorter in supply driving up the cost of fuels and causing inflation throughout the nation and putting more noxious gasses into the air world-wide.
2. As a replacement, currently, one of the many alternatives to ICE vehicles has been Electronic Vehicles (EV's). Thus far, with the exception of a few true Electric Vehicles that are either not street worthy or have been stopped (such as the EV1) all EV cars are either in some form of gas-hybrids with no fully electric vehicles brought to the mainstream market.
   a. The limitation, and, consequently, the major objection with Fully Electric vehicles has been that once the battery wears down, it needs to be recharged. This can be extremely inconvenient for the driver causing him to possibly be stranded far from home or wait many hours for a charge (overnight).
   b. The problem is further exacerbated if the owner lives in an apartment without a garage to securely plug up the vehicle rather than a single house with a garage to ensure no one is illegally obtaining his electricity overnight.
3. Another problem with EV's has been that the size of the battery (or batteries) has had to be extremely large in order to allow the vehicle to go longer distance. The larger the battery, the longer the distance the vehicle can travel.
4. A conundrum occurs because the more batteries added, the heavier the weight burden becomes and that requires more horse-power from the electric motor, thus, requiring a larger, stronger, and heavier engine which then requires more battery power.
5. Other alternatives include:
   a. The electric/gas-hybrid. In this type of vehicle, all the driver would need to do if the battery wore down would be to find a gas station to provide power to the ICE engine. The problem with this alternative is that gas is still necessary and having two types of engines/motors only increases the need for higher technology and parts causing the vehicle to cost more in production.
   b. Gas-Driven Generator. General Motors (GM) is working on technology for a gas-powered motor that recharges the battery for the electric motor of the vehicle. Again, gasoline is the limiting factor and, essentially, two motors would still be needed.

### SPECIFICATION—THE SELF-CHARGING ELECTRIC VEHICLE RANGE EXTENDER COMPONENT

1. My solution would result in a Self-Charging Electric Vehicle Range Extender Component by utilizing current technology, adding a new device (the Sleeve-device), and changing up the Alternator-Utilization process.
2. The electric motor (Prior Art and not part of this patent idea) powered by batteries (Prior Art and not part of this patent idea) would turn the drive train which would turn the axles and turn the rear wheels of the vehicle.
3. The two rear wheels of the vehicle turn both by free motion of the vehicle (coasting) or by force from the electric motor's drive train (powered through the rear axle).
4. The idea is to capture the power generated by the free-motion of the rotation of the wheels both when driven by the axle and when in a coasting mode.
5. No power would be generated by this component when the vehicle is in a standing or idle mode.
6. The idea involves installing two vehicle alternators in each of the two rear wheel hubs of the car for a total of four alternators. These alternators would be connected via belts which would wrap around a new sleeve-device attached to the wheel plates (the part onto which the tire is bolted onto) and going over the axles. (see Plate 3)
7. As the wheels turn independently while driving, the sleeve-device would turn the belts attached to the alternators and provide a charge.
8. Cables would then send the charge to the main battery and/or back up battery system.
9. Depending on the volume of the batteries (small quantity versus large quantity) that would be required to power the motor, the number of alternators could be either 2 or 4 (one or two per wheel).
10. Each of the alternators would be fixed (bolted) to the wheel hub/frame of the vehicle.
11. Ideally, alternators would be installed in the rear of the vehicle since there would be less moving parts (unlike the front two wheels which also turn the direction of the vehicle) perhaps replacing the gas tank.
12. The free-motion of the round sleeve-device turned by the wheel (not the electric motor nor the axle) and attached from the sleeve-device to the alternator via an alternator-belt would cause the alternator to turn which would provide a constant charge for the battery while the vehicle is in motion.
13. The result would be that while the vehicle was in motion, the battery (or batteries depending on the configuration of the EV) would continue to charge. It is not certain for how long the charge will continue to power the vehicle. It may occur that the vehicle will use more battery power than the alternators would produce. It is believed that the vehicle's consumption would/could eventually wear down the battery's energy stores. This would necessitate periodically plugging the vehicle in for full recharging of the batteries.
14. The two front wheels could also have a similar housing set-up except the alternator(s) would turn with the movement of each of the front wheels (left or right) but, for right now for the purposes of explaining this patent idea, this patent submission will concentrate on the rear wheels.
15. In 18-Wheel Truck Vehicles (or vehicles with more than the standard 4 wheels), similar wheel hubs with alternators could also be installed to provide the additional power to the larger electric motors necessary to move the heavier payloads.
16. As a side-benefit of constant-charging batteries, the volume and size of batteries used to power the electric motor would not have to be as large or as many (quantity) as current art requires.
17. This idea is not meant to be a continuous self-charging solution as batteries, even when charging, will still wear down. Plug-in charging will still be required on a periodic basis. It may later become such a reality over time through improved battery technology or in actual testing. This testing has not been accomplished due to financial limitations of the inventor.
18. Battery strength indicators will be necessary to provide the driver with an idea of how much drivability is available/remaining.
19. Battery Type: Unspecified. The size and type of the battery will depend on the vehicle manufacturer.

### Proof of Concept:

1. This patent idea is not an unproven theory. It has been proven and is proven every day when you drive your vehicle.
   a. Each Internal Combustion Engine (ICE) in the world relies on an alternator to power the Air Conditioner, lights, radio, lighters, power windows, seats, and door locks.
   b. The alternators are powered by the engine which turns the fan belts which directly powers the 12-Volt battery. This, in turn, powers all of the electric components of the vehicle except for the ICE itself
2. Clearly, one 12-Volt battery will not generate enough power to turn an electric motor strong enough to drive a normal sized vehicle and passengers.
   a. However, multiple batteries will accomplish this. This has proven by Hulas Electric mini-bus manufacturer in Nepal which uses an 84-Volt system (Essentially, 7 12-Volt Batteries). The 7 batteries operate the engine and all electric devices on the mini-bus such as lights and radio. After about 6 hours or so of driving in town, they stop into a battery station and change out the used batteries for newly charged batteries and continue to pick up paying passengers.
   b. This is also proven with the Tesla Motors company (among others car manufacturers) which use newer technology batteries to power the motors of their electric vehicles.
3. Regardless of whether the batteries used are of the common 12-Volt variety or of newer technology batteries, so long as they can be charged using an alternator, this concept will work to charge an electric motor powerful enough to move a vehicle.
4. I do not have the funds to physically test this patent idea but since it is true that alternators do work and it is also true that alternators do send power to the batteries to power electric devices, it is thusly true that this patent idea will power electric motors necessary to power vehicles.
5. SUMMARY: Using current technology, adding a simple sleeve device, and changing the methodology, a way of extending the range electric vehicles can be accomplished.

I claim:

1. A process of harnessing the energy from the free-motion of a vehicle's wheels, utilizing alternator technology, to provide a recurring charge to the batteries of an electric vehicle and thus extend the driving range of the electric vehicle.
a. claim 1 includes the placement of a sleeve-device over the axle of the wheel.
b. The sleeve-device will turn with the motion of the wheel(s).
i. The sleeve-device will be cylindrical and have grooves to accommodate belts for alternators.
ii. The sleeve-device will be attached to the tire either by weld or by mold.
iii. The sleeve-device will not come in contact with the axle.
c. Alternators will be bolted to the frame of the vehicle. They will be attached to the sleeve-device via alternator belts.
d. Electric power generated from the turning of the alternators will be sent to the batteries of the electric vehicle. This power will help to keep the batteries charged as much as possible in order to extend the driving range of the electric vehicle.
